(19) United States
(12) Patent Application Publication
(10) Pub. No.: US 2013/0278471 A1
(43) Pub. Date: Oct. 24, 2013

(54) ANTENNA FUNCTIONING AS BUTTON AND ELECTRONIC DEVICE USING THE SAME

(71) Applicant: CHIH-CHUNG WENG, Tu-Cheng (TW)

(72) Inventor: CHIH-CHUNG WENG, Tu-Cheng (TW)

(73) Assignee: HON HAI PRECISION INDUSTRY CO., LTD., Tu-Cheng (TW)

(21) Appl. No.: 13/563,765

(22) Filed: Aug. 1, 2012

(30) Foreign Application Priority Data
Apr. 20, 2012 (TW) 101114059

(51) Int. Cl. H01Q 1/22

(52) U.S. Cl. 343/720

(57) ABSTRACT

An electronic device includes an antenna, a fixing part, a housing, a switch, and a number of elastic elements. The fixing part is for fixing the antenna. The housing defines a cavity for receiving the fixing part and a first through hole which communicates with the cavity. The switch passes through the through hole and protrudes into the cavity. The number of elastic elements fixed on the housing and protrudes into the cavity. When the antenna is not pushed, the fixing part keeps a certain distance from the inner wall of the cavity. When the antenna is pushed to move, the antenna drives the fixing part to push the numbers of elastic element and contact the switch to trigger the switch.

### BACKGROUND

1. Technical Field

The present disclosure relates to an electronic device with an antenna, and, particularly, to an antenna of an electronic device that can be used as a button for the electronic device.

2. Description of Related Art

Some electronic devices include a button for turning on/off the electronic device and an antenna for receiving wireless signals. The button and the antenna both occupy certain space in the electronic device, thus results in the electronic device cannot be miniaturized.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of an electronic device with an antenna in accordance with an exemplary embodiment.

FIG. 2 is an explored view of the electronic device of FIG. 1.

FIG. 3 is a view similar to FIG. 2, but viewed from a different perspective.

FIG. 4 is a cross-sectional view taken along line IV-IV of FIG. 1.

FIG. 5 is a view similar to FIG. 4, but showing when the antenna of the electronic device of FIG. 1 is pushed.

FIG. 6 is a view similar to FIG. 4, but showing when the antenna body of the antenna of the electronic device of FIG. 1 is pulled out from an antenna receiver of the antenna of the electronic device of FIG. 1.

FIG. 7 is a view similar to FIG. 4, but showing when the antenna of the electronic device of FIG. 1 is rotated.

### DETAILED DESCRIPTION

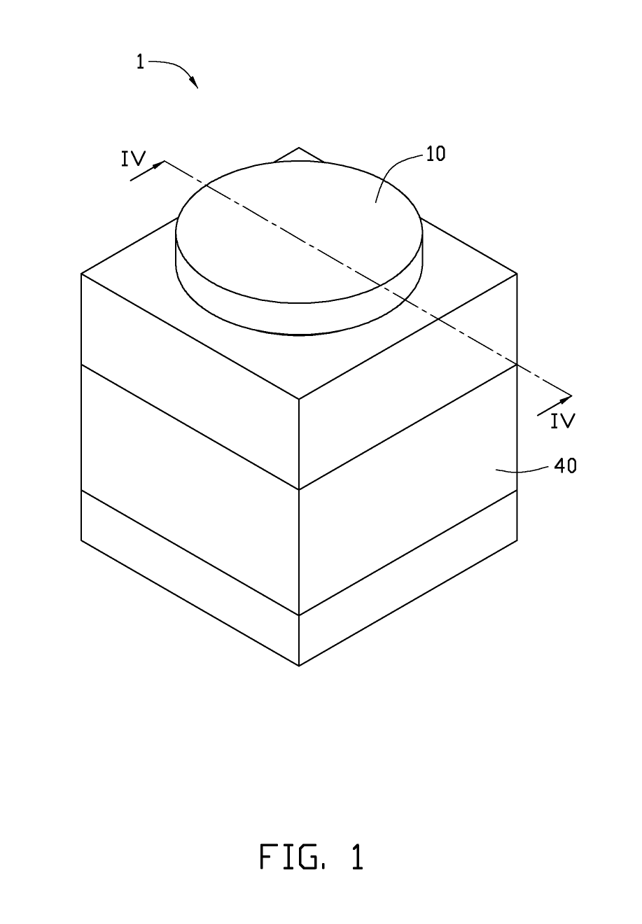

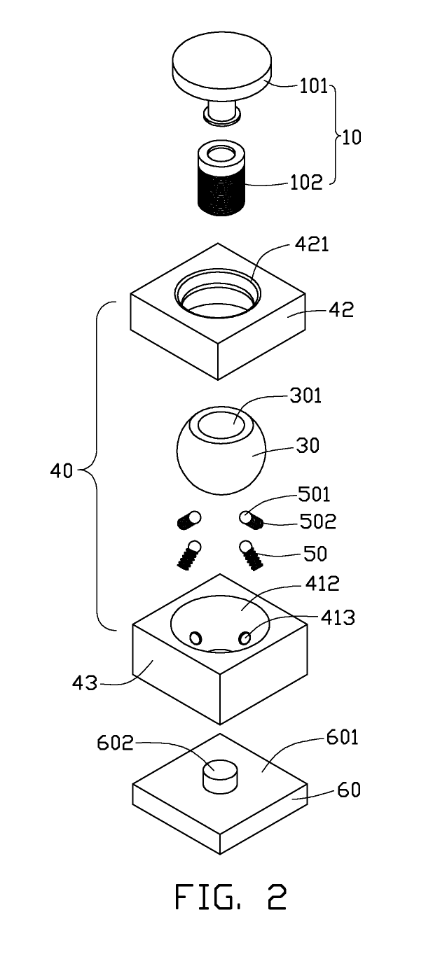

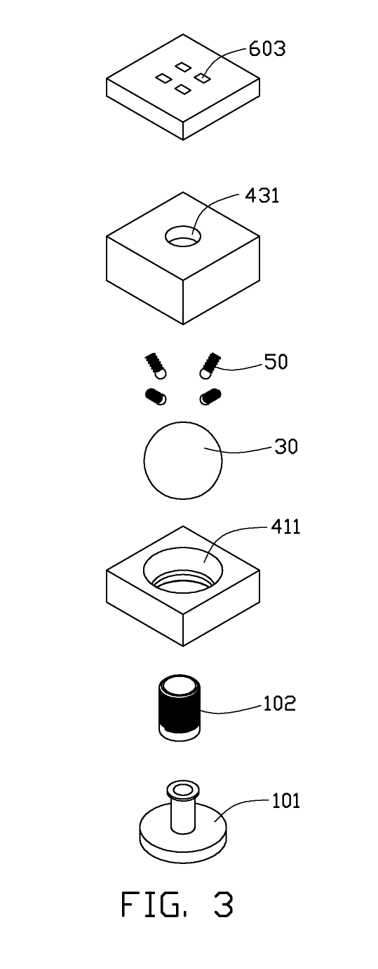

FIGS. 1-3 show an electronic device 1 in accordance to one embodiment. The electronic device 1 includes an antenna 10, a fixing part 30, a housing 40, at least one elastic element 50, and a switch 60. The antenna 10 includes an antenna body 101 and an antenna receiver 102. The antenna body 101 is received in the antenna receiver 102 and can be extended from the antenna receiver 102 to receive wireless signals.

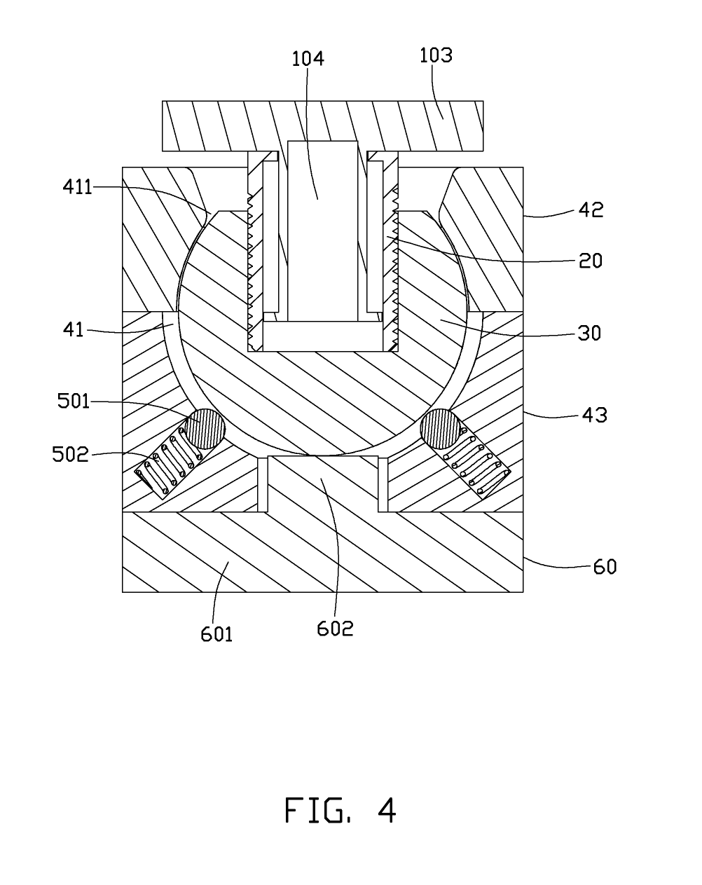

The antenna receiver 102 is fixed to the fixing part 30. In the embodiment, the fixing part 30 includes a blind hole 301, into which the antenna receiver 102 is fixedly inserted. The housing 40 defines a cavity 41 (as shown in FIG. 4) for receiving the fixing part 30. The volume of the cavity 40 is larger than the volume of the fixing part 30, so that the fixing part 30 can be moved in the cavity 41.

In the embodiment, the housing 40 includes a first housing 42 and a second housing 43. The first housing 401 defines a first receiver 411 and the second housing 43 defines a second receiver 412. The first receiver 411 and the second receiver 412 form the cavity 41. The fixing part 30 contacts the inner wall of the first receiver 411. The first housing 42 defines a first through hole 421 which communicates with the first receiver 411. The antenna receiver 102 is fixed to the fixing part 30 by passing through the first through hole 421.

In the embodiment, the fixing part 30 is sphere-shaped. The inner wall of the first receiver 411 is a part of a first spherical surface and the inner wall of the second receiver 411 is a part of a second spherical surface. The diameter of the second spherical surface is larger than the diameter of the first spherical surface, so that the fixing part 30 contacts the first receiver 411 but does not contact the second receiver 412.

Referring to FIG. 4, the elastic element 50 is fixed to the second housing 43 and protrudes out of the inner wall of the first receiver 412, namely protrudes into the cavity 41. In the embodiment, the elastic element 50 is a ball spring which includes a ball 501 and a spring 502. The ball 501 is connected to one end of the spring 502. In the embodiment, four ball springs 50 are used for example. The inner wall of the second receiver 412 defines four blind holes 413. The other end of the spring 502 is fixed to the bottom of one blind hole 413. The ball 501 protrudes out of the inner wall of the second receiver 412, namely protrudes into the cavity 41.

The switch 60 includes a body 601 and a trigger 602. The body 601 includes switch circuit board (not shown) and a number of conductive patches 603, which electrically connect the switch circuit board to a circuit board of an electronic device (not shown). The second housing 43 further includes a second through hole 431. The trigger 602 passes through the second through hole 431 to contact the fixing part 30. The trigger 602 is pushed by the fixing part 30 to turn the electronic device 1 on/off, or select a function of the electronic device 1.

When the antenna 1 is not pushed, one end of the fixing part 30 contacts the inner wall of the first receiver 411, the other end of the fixing part 30 contacts the trigger 602 and the elastic element 50 and keeps a certain distance from the inner wall of the second receiver 412.

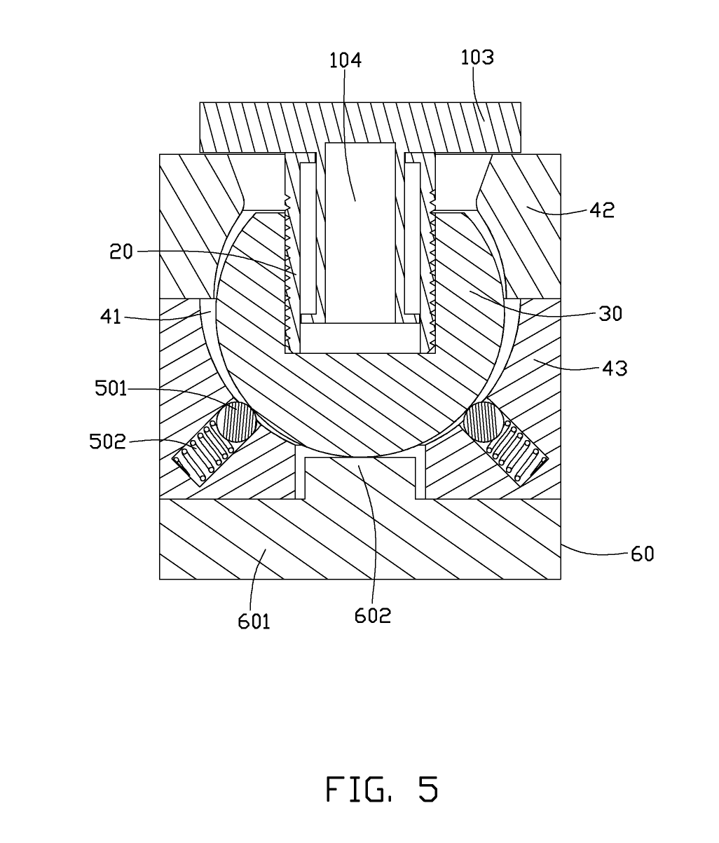

Referring to FIG. 5, when the antenna body 101 is received in the antenna receiver 102 and the antenna body 101 is pushed to move, the antenna body 101 drives the fixing part 30 to push the ball spring 50, and contact the trigger 602 of the switch 60 to trigger the trigger 602 of the switch 60.

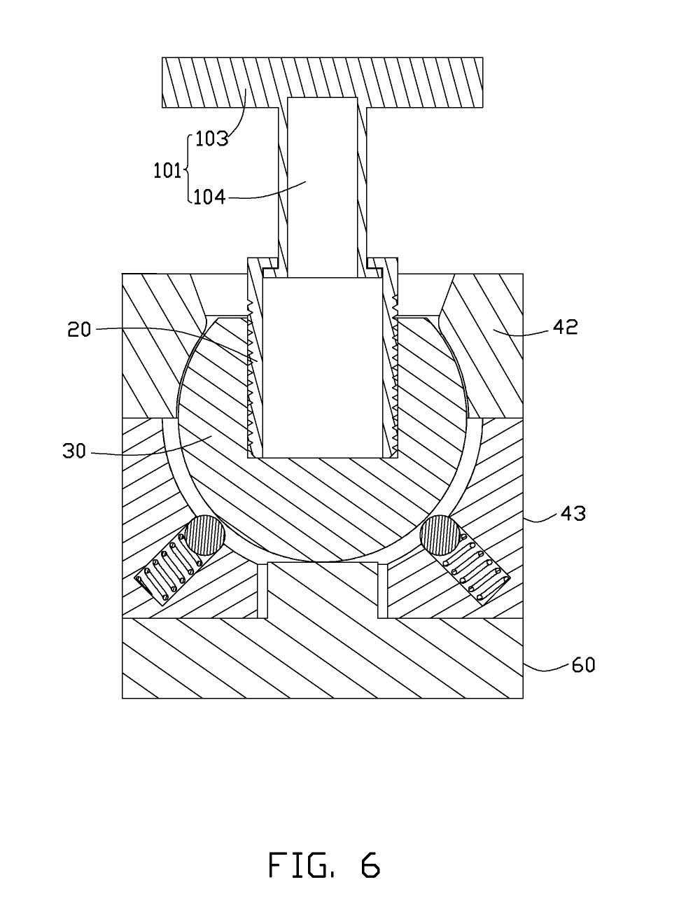

In the embodiment, as shown in FIG. 6, the antenna body 101 includes a pushing part 103 and a pole 104. The pushing part 103 is connected to the pole 104 and cannot pass through the first through hole 421. The pole 104 is received in the antenna receiver 102 and can be pulled out from the antenna receiver 102. In the embodiment, the pushing part 103 is a circle panel. The diameter of the pushing part 103 is larger than that of the first through hole 421, so that, the pushing part 103 cannot pass through the first through hole 421. As shown in FIG. 4, when the pole 104 is completely received in the antenna receiver 102 and the pushing part 103 is not pushed, the pushing part 103 has a distance from the first housing 42.

As shown in FIG. 5, when the pushing part 103 is pushed to move to the first housing 42, the movement of the pushing part 103 drives the fixing part 30 to trigger the trigger 602 of the switch 60.

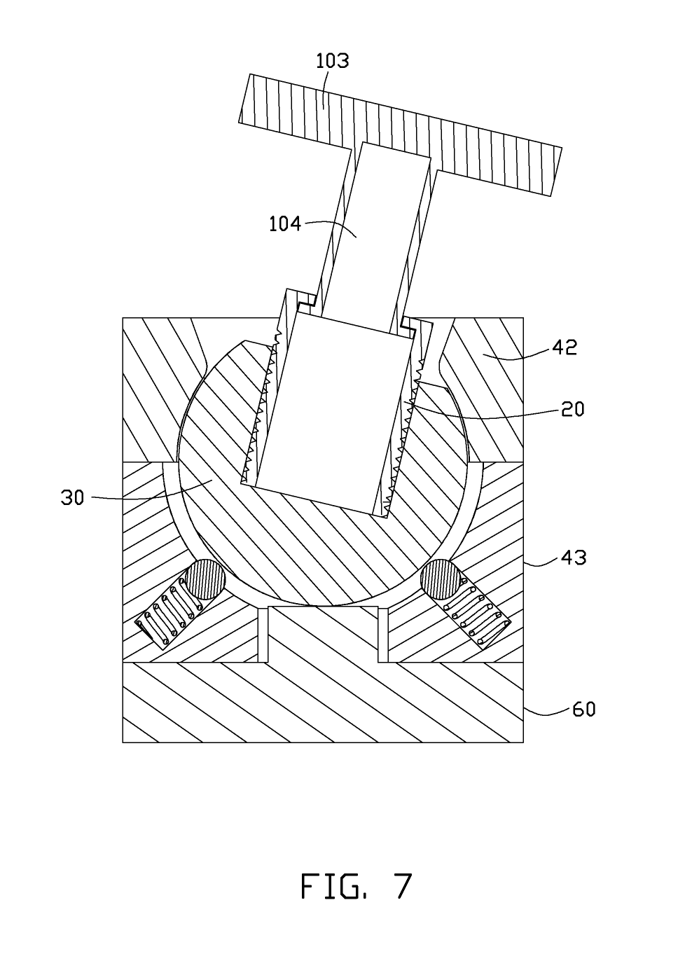

As shown in FIG. 7, due to the fixing part 30 being a sphere and contacting the inner wall of the first receiver 411. When the antenna body 101 is pulled out from the antenna receiver 102, the fixing body 30 is capable of rotating in the first receiver 411 for rotating the antenna 10 to receive the wireless signal from different directions.

Although, the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. An electronic device comprising:
an antenna;
a fixing part for fixing the antenna;
a housing defining a cavity for receiving the fixing part and a first through hole communicating with the cavity;
a switch for passing through the through hole and protruding into the cavity;
at least one elastic element fixed on the housing and protruding into the cavity and supporting the fixing part;
wherein, when the antenna is not pushed, the fixing part keeps a certain distance from an inner wall of the cavity and the switch, and when the antenna is pushed to move, the antenna drives the fixing part to push the at least one elastic element and contact the switch to trigger the switch.

2. The electronic device as described in claim 1, wherein the antenna comprises an antenna body and an antenna receiver, the antenna body is received in the antenna receiver and is capable of extending from the antenna receiver to receive wireless signals, and the antenna receiver is fixed to the fixing part.

3. The electronic device as described in claim 2, wherein the fixing part comprises a blind hole, into which the antenna receiver is fixed.

4. The electronic device as described in claim 2, wherein the housing comprises a first housing and a second housing, the first housing defines a first receiver and the second housing defines a second receiver, the first receiver and the second receiver form the cavity, the fixing part contacts the inner wall of the first receiver and keeps a certain distance from the inner wall of the second receiver when the antenna is not pushed.

5. The electronic device as described in claim 4, wherein the first housing defines a second through hole which communicates with the first receiver, the antenna receiver is fixed to the fixing part by passing through the second through hole.

6. The electronic device as described in claim 5, wherein the antenna body comprises a pushing part and a pole, the pushing part is connected to the pole, the pole is received in the antenna receiver, the pushing part is prevented from passing through the second through hole, and when the pole is completely received in the antenna receiver and the pushing part is not pushed, the pushing part has a distance from the first housing.

7. The electronic device as described in claim 4, wherein the fixing part is sphere-shaped, the inner wall of the first receiver is a part of a first spherical surface and the inner wall of the second receiver is a part of a second spherical surface, the diameter of the second spherical surface is larger than the diameter of the first spherical surface.

8. The electronic device as described in claim 4, wherein the at least one elastic element is a ball spring, each of the at least one elastic element comprises a ball and a spring, the ball is connected to one end of the spring and protrudes out of the cavity, the inner wall of the second receiver defines at least one blind hole, the other end of the spring is fixed to the bottom of one of the at least one blind hole.

9. The electronic device as described in claim 1, wherein the number of the at least one elastic element is four.

10. The electronic device as described in claim 1, wherein the switch comprises a body and a trigger, the trigger passes through the first through hole to contact the fixing part.
